(19) United States
(12) Patent Application Publication
(10) Pub. No.: US 2026/0244630 A1
(43) Pub. Date: Aug. 20, 2026

(54) SIMILARITY MATCHING USING COMPUTE-IN-MEMORY

(71) Applicant: OpenAI Opco, LLC, San Francisco, CA (US)

(72) Inventor: Mohammed Elneanaei Abdelmoneem FOUDA, Alexandria, VA (US)

(73) Assignee: OpenAI Opco, LLC, San Francisco, CA (US)

(21) Appl. No.: 19/542,383

(22) Filed: Feb. 17, 2026

Related U.S. Application Data
(60) Provisional application No. 63/759,888, filed on Feb. 18, 2025.

(51) Int. Cl. G06F 16/2458; G06N 3/042

(52) U.S. Cl. CPC G06F 16/2468; G06N 3/042

(57) ABSTRACT

Similarity matching operations in retrieval-augmented generation (RAG) systems face challenges in balancing retrieval latency, memory bandwidth, and energy efficiency. To address these challenges, the disclosed technology provides a memory system architecture including similarity circuitry configured to perform similarity matching within or near the memory. The similarity circuitry receives a search vector, determines similarities between the search vector and stored embedding vectors, identifies one or more matched embedding vectors based on the similarities, and outputs information corresponding to the matched embedding vectors. Only the matched embedding vectors are transferred out of the memory system, substantially reducing data movement compared to conventional approaches. By performing similarity matching within or near the memory, the disclosed technology improves energy efficiency and reduces latency for retrieval operations.

### CROSS-REFERENCE TO RELATED APPLICATIONS

This application claims the benefit, pursuant to 35 U.S.C. § 119 (e) and 37 C.F.R. § 1.78(a), of U.S. Provisional Application No. 63/759,888, filed Feb. 18, 2025. The disclosure of U.S. Provisional Application No. 63/759,888 is hereby incorporated by reference herein in its entirety.

### BACKGROUND

Artificial intelligence (AI) and machine learning applications increasingly rely on retrieval-augmented generation (RAG) systems to enhance the accuracy and relevance of generated responses. RAG systems retrieve relevant information from large document databases and provide this context to large language models (LLMs) during inference. As database sizes grow to millions or billions of embedding vectors, the retrieval process becomes a critical bottleneck affecting overall system latency and energy consumption.

These workloads impose substantial demands on memory systems. Similarity matching operations require comparing a search vector against a large number of stored embedding vectors to identify the most relevant matches. In high-performance configurations, such as data centers and cloud computing environments, multiple retrieval queries may be processed concurrently, compounding the memory bandwidth requirements and increasing energy consumption.

Achieving fast and efficient similarity matching across large embedding databases remains a central challenge in RAG systems, as conventional architectures struggle to balance retrieval latency, memory bandwidth, and power efficiency at scale. Conventional approaches to similarity matching transfer all embedding vectors from memory to an external processor for comparison, resulting in substantial data movement that increases latency and energy consumption as the size of the embedding database grows. These inefficiencies are amplified in AI workloads where retrieval operations are frequent and memory bandwidth is a critical resource.

### SUMMARY

The disclosed technology provides benefits and solves one or more of the above-mentioned challenges through a memory system architecture that includes similarity circuitry configured to perform similarity matching within or near the memory. The similarity circuitry receives a search vector, determines similarities between the search vector and stored embedding vectors, identifies one or more matched embedding vectors based on the similarities, and outputs the matched embedding vectors. By performing similarity matching within or near the memory, the disclosed technology reduces data movement between the memory and an external processor, improving energy efficiency and reducing latency.

The disclosed technology can minimize data transfer by performing similarity computations as embedding vectors are read from memory, rather than transferring all embedding vectors to an external processor. In some implementations, the similarity circuitry is disposed within a memory unit at read ports of memory banks, enabling similarity computations to be performed as embedding vectors are read from the memory banks. By positioning the similarity circuitry at or in proximity to the read ports, similarity computations may be performed on embedding vectors as they are read from the memory banks, without transferring the embedding vectors to an external processor or bus.

In some implementations, the similarity circuitry is disposed within a logic die of a high bandwidth memory, enabling similarity computations to be performed within the memory stack. The memory banks may be searched in parallel, and within each memory bank, the similarity circuitry may search row by row.

In some implementations, the similarity circuitry is configured to identify a predetermined number of matched embedding vectors with highest similarities to the search vector. Only the matched embedding vectors are transferred out of the memory system, substantially reducing data movement compared to conventional approaches. The memory system may be configured to perform retrieval in a retrieval-augmented generation (RAG) system, where the search vector includes an embedded representation of a query and the embedding vectors include embedded representations of document chunks.

Further, in some implementations of the disclosed technology, a memory system can include memory circuitry configured to store embedding vectors, and similarity circuitry configured to receive a search vector, determine similarities between the search vector and the embedding vectors, identify one or more matched embedding vectors based on the similarities, and output the one or more matched embedding vectors. In this configuration, performing similarity matching within or near the memory circuitry reduces data transfer to an external processor, thereby improving memory bandwidth utilization and lowering power consumption.

In some implementations, disclosed systems may perform a method for similarity matching. The method includes storing embedding vectors in memory circuitry, receiving at similarity circuitry a search vector, determining by the similarity circuitry similarities between the search vector and the embedding vectors, identifying one or more matched embedding vectors based on the similarities, and outputting the one or more matched embedding vectors. The method enables similarity matching to be performed with reduced data movement, improving energy efficiency and latency for retrieval-augmented generation workloads.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates a diagram of an example of a retrieval-augmented generation system, in accordance with some aspects of the present technology.

FIG. 2 illustrates a diagram of an example of a conventional memory system for similarity matching, in accordance with some aspects of the present technology.

FIG. 3 illustrates a diagram of an example of a memory system with similarity circuitry disposed within a memory unit, in accordance with some aspects of the present technology.

FIG. 4 illustrates a diagram of an example of a memory system with similarity circuitry disposed within a logic die of a high bandwidth memory, in accordance with some aspects of the present technology.

FIG. 5 illustrates a flow chart of an example of a method for similarity matching using a memory system, in accordance with some aspects of the present technology.

FIG. 6 illustrates a table of example parameters for performance analysis of memory systems for similarity matching, in accordance with some aspects of the present technology.

FIG. 7 illustrates a table of example performance results for conventional, similarity-in-DRAM (SID), and similarity-near-DRAM (SND) memory system configurations, in accordance with some aspects of the present technology.

FIG. 8 illustrates a table of example expected gains for similarity-in-DRAM (SID) and similarity-near-DRAM (SND) memory system configurations, in accordance with some aspects of the present technology.

### DETAILED DESCRIPTION

The following disclosure provides various embodiments and examples for implementing features of the invention. Specific examples of components and arrangements are described to simplify the present disclosure. These examples are not intended to be limiting. For instance, the formation of a first feature over or on a second feature may include embodiments in which the two features are in direct contact, as well as embodiments in which additional features are interposed between them. Reference numerals and/or letters may be repeated across examples for clarity and simplicity, and such repetition does not imply a specific relationship between embodiments.

Some of the disclosed embodiments are described with reference to the accompanying drawings. However, it will be understood by those skilled in the art that the principles of the example methods and systems may be practiced without every specific detail. Well-known methods, procedures, and components have not been described in detail so as not to obscure the principles of some of the disclosed methods and systems. Unless explicitly stated, the example methods and processes described herein are neither constrained to a particular order or sequence nor constrained to a particular system configuration. Additionally, some of the described methods and systems or elements thereof can occur or be performed (e.g., executed) simultaneously, at the same point in time, or concurrently. Reference will now be made in detail to some of the disclosed methods and systems, examples of which are illustrated in the accompanying drawings.

It is to be understood that both the foregoing general description and the following detailed description are only explanatory and are not restrictive of this disclosure. The accompanying drawings, which are incorporated in and constitute a part of this specification, illustrate several disclosed methods and systems and together with the descriptions serve to outline principles of some of the disclosed methods and systems.

Spatially relative terms such as “beneath,” “below,” “lower,” “above,” “upper,” and similar descriptors are used for convenience in describing the relative positioning of elements as illustrated in the figures. These terms are intended to encompass different orientations of the device in use or operation, and should not be interpreted as limiting the scope of the invention to the depicted orientation.

Retrieval-augmented generation (RAG) has emerged as a method for improving language models by incorporating external knowledge sources. In RAG systems, reference materials such as documents are chunked, embedded using an encoder model, and stored in a database. During inference, a query is embedded and compared against stored embeddings to retrieve relevant chunks, which are then provided to a large language model (LLM) to generate a response. However, RAG systems face challenges including retrieval latency, data movement overhead, and system complexity. More advanced RAG systems, such as agentic RAG, generate multiple queries for a single input, further compounding these latency challenges.

Conventional approaches to similarity matching transfer embedding vectors from memory to a processor for comparison, resulting in substantial data movement. Embedding vectors are numerical representations of data, such as text, images, or other content, generated by encoder models such as neural networks. Unlike arbitrary numerical vectors, embedding vectors capture semantic relationships, such that similar content produces vectors that are close together in vector space.

In RAG systems, embedding vectors typically represent document chunks or queries, with dimensions ranging from hundreds to thousands of elements (e.g., 1024 dimensions). As embedding databases grow in size, this data transfer becomes a bottleneck, consuming significant energy and increasing latency. Accordingly, there is a need for memory architectures that perform similarity matching closer to where data is stored, reducing data movement and improving energy efficiency.

In conventional memory systems, data flows from memory dies through a memory controller to a processor. For example, embedding vectors stored in DRAM dies are read out to a memory controller, which manages data transfer to an external processor such as a CPU, GPU, or other processing unit. The processor then performs similarity matching operations on the embedding vectors. This conventional data path requires all embedding vectors to pass through the memory controller and be transferred to the processor for comparison, resulting in substantial data movement and memory bandwidth consumption.

The disclosed technology addresses this bottleneck by positioning similarity circuitry before the memory controller in the data path. By inserting similarity circuitry between the memory dies and the memory controller, similarity matching operations can be performed on embedding vectors as they are read from memory, before the data reaches the memory controller. This configuration enables the memory system to filter embedding vectors based on similarity and transfer only the matched embedding vectors through the memory controller to the processor, substantially reducing data movement compared to conventional approaches.

Although the disclosed technology is described with reference to RAG systems, the memory system architecture is applicable to other applications that rely on similarity matching of embedding vectors. Embedding-based similarity matching is used in a variety of applications where data is represented as high-dimensional vectors and similarity or distance computations are performed to identify relevant matches.

For example, the disclosed technology may be used in recommendation systems, where user preferences and item characteristics are represented as embedding vectors and similarity matching is performed to identify recommended items. The disclosed technology may also be used in image or video retrieval systems, where visual content is encoded as embedding vectors and similarity matching is performed to identify visually similar content. Other applications may include k-nearest neighbor classification, semantic search, anomaly detection, and other machine learning workloads that involve comparing a query vector against a database of stored vectors.

The disclosed technology provides a memory system configured to perform similarity matching. The memory system includes memory circuitry configured to store embedding vectors and similarity circuitry configured to receive a search vector, determine similarities between the search vector and the stored embedding vectors, identify one or more matched embedding vectors based on the similarities, and output information corresponding to the matched embedding vectors. By integrating similarity matching functionality within or near the memory circuitry, the disclosed technology reduces data movement between memory and processor, improving energy efficiency and reducing latency.

In some implementations, the memory system is configured to perform retrieval in an RAG system. In RAG systems, reference materials such as documents are divided into chunks, and each chunk is converted into an embedding vector using an encoder model. These embedding vectors are stored in the memory circuitry. When a query is received, the query is similarly embedded to produce a search vector. The similarity circuitry compares the search vector against the stored embedding vectors to identify relevant matches. The matched embedding vectors may then be reranked and provided to a language model to generate a response.

The similarity circuitry determines similarities between the search vector and the stored embedding vectors using a similarity metric. In some implementations, the similarity metric may include cosine similarity, dot product, Euclidean distance, or other distance or similarity measures. Based on the determined similarities, the similarity circuitry identifies one or more matched embedding vectors. In some implementations, the similarity circuitry is configured to identify a predetermined number of matched embedding vectors with the highest similarities to the search vector, such as the top-K most similar embedding vectors.

The similarity metric used by the similarity circuitry may be selected based on the application requirements. Dot product similarity may be used when computational simplicity is desired, as dot product computation involves multiplication and accumulation operations without normalization. Cosine similarity may be used when the magnitude of the embedding vectors should be normalized, such that similarity is based on the angle between vectors rather than their magnitudes. Euclidean distance may be used when the absolute distance between vectors in the embedding space is relevant.

In some implementations, the similarity circuitry includes configurable arithmetic units that can compute different similarity metrics based on a configuration setting. For example, the similarity circuitry may include multipliers for multiplication, adders for accumulation, and optional normalization logic that can be enabled or bypassed depending on the selected similarity metric. This configurability enables the memory system to support different applications with varying similarity metric requirements.

The similarity circuitry may implement various mechanisms for identifying the top-K matched embedding vectors. In some implementations, the similarity circuitry maintains a data structure that tracks the K embedding vectors with the highest similarity scores encountered during the similarity matching operation. As each embedding vector is compared against the search vector, the similarity circuitry determines whether the similarity score exceeds the lowest score in the current top-K set, and if so, updates the top-K set accordingly.

In some implementations, the similarity circuitry uses a min-heap data structure to track the top-K matched embedding vectors. The min-heap maintains the K embedding vectors with the highest similarity scores, with the minimum score at the root of the heap. When a new embedding vector has a similarity score higher than the minimum score in the heap, the similarity circuitry replaces the root of the heap with the new embedding vector and re-heapifies the data structure. This approach enables efficient tracking of the top-K matches with logarithmic time complexity for each update.

In some implementations, the similarity circuitry uses threshold-based filtering to reduce the number of candidate embedding vectors before ranking. The similarity circuitry may compare each similarity score against a threshold value and discard embedding vectors with similarity scores below the threshold. The remaining candidate embedding vectors may then be sorted or ranked to identify the top-K matches. This two-stage approach may reduce computational overhead by eliminating low-similarity candidates early in the matching process.

In some implementations, the similarity circuitry includes dedicated hardware for top-K identification, such as parallel comparators, sorting networks, or other logics. The parallel comparators may compare similarity scores simultaneously to identify candidates for the top-K set. A sorting network may rank the candidate embedding vectors based on their similarity scores to produce an ordered list of the top-K matches. The use of dedicated hardware enables the similarity circuitry to identify top-K matches with low latency, supporting real-time similarity matching applications.

In some implementations, the similarity circuitry comprises multiple similarity circuits. The search vector may be distributed to the multiple similarity circuits, enabling parallel similarity computations across different portions of the stored embedding vectors. In some implementations, the similarity circuitry is configured to receive multiple search vectors and determine similarities for the multiple search vectors, enabling batch processing of queries.

In some implementations, the memory circuitry comprises multiple memory banks within a memory unit, and the similarity circuitry is disposed within the memory unit. As used herein, a memory unit may include a memory die, a memory package, a memory module, or other memory structures.

The similarity circuitry may be disposed within the memory unit in various configurations. For example, the similarity circuitry may be integrated on the memory unit, implemented in the memory unit, located on a logic die of the memory unit, coupled to read ports of the memory unit, within the same package as memory banks, or within a stacked memory device. The similarity circuitry may be disposed at read ports of the memory banks, enabling similarity computations to be performed as embedding vectors are read from the memory banks.

The memory banks may be configured to be searched in parallel, with multiple similarity circuits simultaneously comparing the search vector against embedding vectors from different memory banks. In some implementations, at least a subset of the plurality of memory banks are associated with respective similarity circuits, enabling parallel similarity computations across the associated memory banks. Within each memory bank, the similarity circuitry may search row by row, sequentially comparing embedding vectors as they are read from each row.

In some implementations, the similarity circuits may be shared among multiple memory banks. For example, if one memory bank completes its similarity computations faster than another memory bank, the similarity circuit associated with the faster memory bank may be allocated to assist with similarity computations for the slower memory bank. This dynamic allocation of similarity circuits enables load balancing across the memory banks, improving overall throughput and resource utilization.

By sharing similarity circuits among memory banks, the memory system can accommodate variations in memory bank access times and similarity computation workloads. This flexibility allows the memory system to maintain high throughput even when some memory banks experience delays due to refresh operations, access conflicts, or other factors that may affect memory bank availability.

In some implementations, the memory system comprises multiple memory units and a logic die arranged in a stacked configuration. The similarity circuitry may be disposed within the logic die. In some implementations, the multiple memory units and the logic die comprise a high bandwidth memory (HBM). The similarity circuitry in the logic die is configured to determine similarities in parallel for embedding vectors stored across the multiple memory units. This configuration enables similarity matching to be performed near the memory units, reducing data transfer compared to transferring embedding vectors to an external processor.

In some implementations, the similarity circuitry is fabricated using complementary metal-oxide-semiconductor (CMOS) technology. The similarity circuits may be implemented using the same CMOS process technology as the memory controller or other logic components in the memory system. This compatibility with standard CMOS fabrication processes enables the similarity circuitry to be integrated into existing memory system architectures without requiring specialized manufacturing processes.

For the similarity-near-DRAM (SND) configuration, the logic die may be fabricated using a CMOS process, and the similarity circuits may be integrated on the logic die alongside other control and interface circuitry. The CMOS-based similarity circuits may include arithmetic units for computing similarity metrics, comparators for identifying matched embedding vectors, and control logic for coordinating similarity operations across multiple memory units.

In some implementations, the similarity circuitry is configured to process multiple search vectors in parallel. Each search vector may be processed by a separate set of similarity circuits, or the similarity circuits may be time-multiplexed to handle multiple search vectors concurrently. Parallel processing of multiple search vectors enables the memory system to achieve higher throughput for batch queries, such as when multiple users submit queries simultaneously or when an application generates multiple related queries.

When processing multiple search vectors in parallel, the similarity circuitry may maintain separate result buffers for each search vector. Each result buffer may store the matched embedding vectors or information corresponding to the matched embedding vectors for a respective search vector. The results for each search vector may be output separately or aggregated for transfer to the processor.

In some implementations, the memory system further comprises a processor coupled to the similarity circuitry. The processor is configured to receive the one or more matched embedding vectors from the similarity circuitry. In some implementations, the processor is configured to perform inference using the matched embedding vectors. By performing similarity matching within or near the memory circuitry, only information corresponding to the matched embedding vectors is transferred out of the memory system to the processor, rather than transferring all stored embedding vectors. This approach substantially reduces data movement between the memory and processor, resulting in improved energy efficiency and reduced latency compared to conventional architectures that transfer all embedding vectors to an external processor for comparison.

In some implementations, the similarity circuitry outputs the matched embedding vectors to a processor or other downstream component. In some implementations, the similarity circuitry outputs information corresponding to the matched embedding vectors, such as indices, memory addresses, or identifiers of the matched embedding vectors. By outputting information corresponding to the matched embedding vectors rather than the full vector data, the memory system can further reduce data movement between the memory and processor.

The information corresponding to the matched embedding vectors may be output in various formats depending on the requirements of the downstream processor or application. In some implementations, the similarity circuitry outputs the full matched embedding vectors for applications that require the vector data for further processing. In other implementations, the similarity circuitry outputs indices or memory addresses of the matched embedding vectors, enabling the processor to retrieve the vector data directly from memory if needed.

In some implementations, the similarity circuitry outputs similarity scores along with the matched embedding vectors or their identifiers. The similarity scores indicate the degree of similarity between each matched embedding vector and the search vector. The similarity scores may be used by the processor for reranking, filtering, or weighting the matched embedding vectors in downstream processing. For example, in a RAG system, the similarity scores may be used to weight the relevance of retrieved context when generating a response.

In some aspects, the disclosed technology provides a method for similarity matching. The method includes storing embedding vectors in memory circuitry, receiving a search vector at similarity circuitry, determining similarities between the search vector and the stored embedding vectors, identifying one or more matched embedding vectors based on the similarities, and outputting the matched embedding vectors. In some implementations, the method further includes distributing the search vector to multiple similarity circuits and transferring the matched embedding vectors to a processor. In some implementations, the method includes receiving multiple search vectors and determining similarities for the multiple search vectors.

Reference is now made to the drawings, which depict illustrative, non-limiting examples provided to facilitate understanding of the subject matter disclosed. The figures are not drawn to scale and are presented for explanatory purposes. Like reference numerals refer to like elements throughout the views. Features shown in connection with a particular figure or embodiment may be combined with, substituted for, or omitted relative to features shown in other figures. Certain conventional elements may be simplified or not shown to avoid obscuring pertinent details. Positional terms (e.g., “upper,” “lower,” “front,” “rear”) are used for convenience of description and do not imply a required orientation. Flow diagrams may represent operations that can be performed in different orders, in parallel, with steps added or omitted.

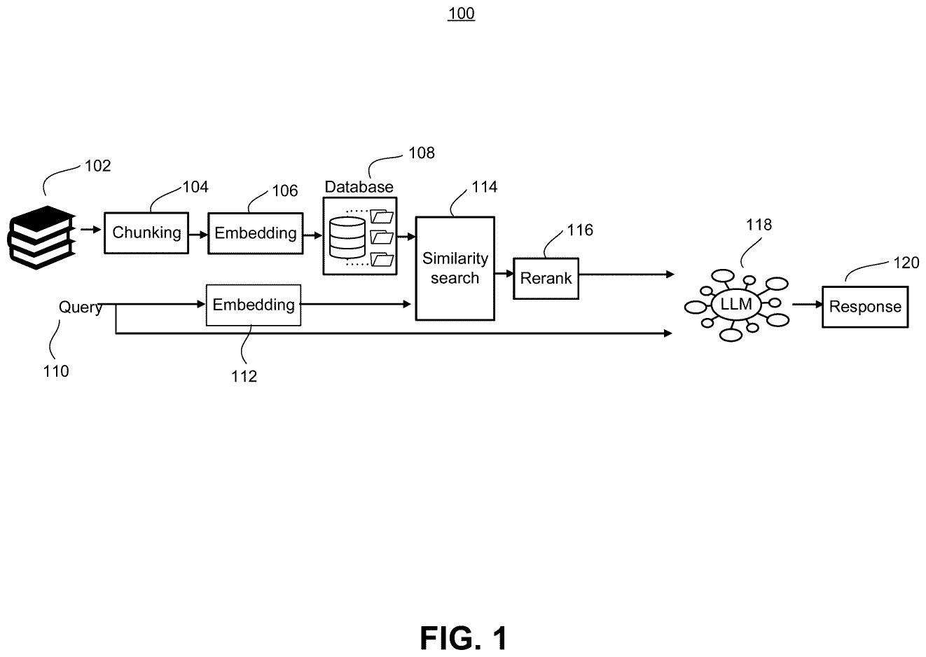

FIG. 1 illustrates a diagram of an example of a RAG system 100, in accordance with some aspects of the present technology. As shown in FIG. 1, RAG system 100 may include source documents 102, a chunking module 104, an embedding module 106, a vector database 108, a query 110, a query embedding module 112, a similarity search module 114, a rerank module 116, a large language model (LLM) 118, and a response 120.

Source documents 102 may include books, articles, or other reference materials to be indexed for retrieval. Chunking module 104 may be configured to divide source documents 102 into smaller segments, such as sentences, paragraphs, or fixed-size chunks. Embedding module 106 may be configured to convert each chunk into an embedding vector using an encoder model. The embedding vectors may be stored in vector database 108 for subsequent retrieval.

When query 110 is received, query embedding module 112 may convert the query into a search vector using an encoder model. Similarity search module 114 may compare the search vector against the embedding vectors stored in vector database 108 to identify matched embedding vectors. Rerank module 116 may rank the matched embedding vectors based on relevance to the query. The top-ranked results may be provided to LLM 118 along with query 110, and LLM 118 may generate response 120 based on the query and the retrieved context.

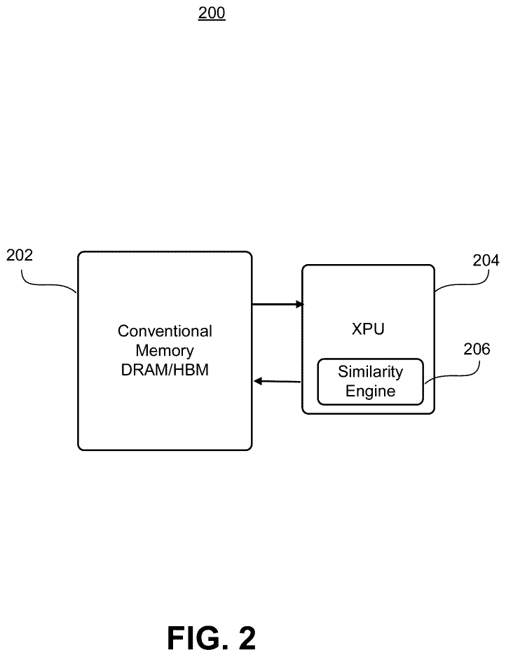

FIG. 2 illustrates a diagram of an example of a conventional memory system 200 for similarity matching, in accordance with some aspects of the present technology. As shown in FIG. 2, conventional memory system 200 may include memory 202, a processor 204, and a similarity engine 206. Memory 202 may comprise DRAM, HBM, or other suitable memory technologies configured to store embedding vectors.

In conventional memory system 200, embedding vectors stored in memory 202 may be transferred to processor 204 for similarity matching. Processor 204 may be an XPU such as a CPU, GPU, TPU, NPU, or other processing unit. Similarity engine 206 may be coupled to processor 204 and configured to compare a search vector against the embedding vectors to identify matched embedding vectors. This conventional approach transfers all embedding vectors from memory 202 to processor 204 for comparison, resulting in substantial data movement that increases latency and energy consumption as the size of the embedding database grows.

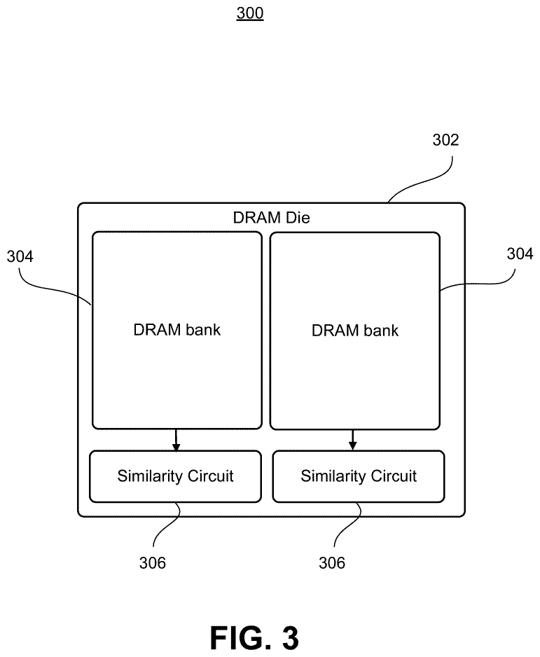

FIG. 3 illustrates a diagram of an example of a memory system 300 with similarity circuitry disposed within a memory unit, in accordance with some aspects of the present technology. Memory system 300 may be referred to as a similarity-in-DRAM (SID) configuration. As shown in FIG. 3, memory system 300 may include a DRAM die 302, DRAM banks 304, and similarity circuits 306.

DRAM die 302 may include multiple DRAM banks 304 configured to store embedding vectors. Each DRAM bank 304 may store a portion of the embedding vectors in the database. DRAM banks 304 may be organized in rows, with each row storing one or more embedding vectors.

Similarity circuits 306 may be disposed within DRAM die 302 at read ports of DRAM banks 304. This configuration enables similarity computations to be performed as embedding vectors are read from DRAM banks 304, without transferring the embedding vectors to an external processor. Similarity circuits 306 may receive a search vector and compare the search vector against embedding vectors read from DRAM banks 304 to determine similarities.

In some implementations, DRAM banks 304 may be searched in parallel, with each similarity circuit 306 simultaneously comparing a search vector against embedding vectors from a corresponding DRAM bank 304. Within each DRAM bank 304, similarity circuits 306 may search row by row, sequentially reading and comparing embedding vectors from each row. By performing similarity matching within DRAM die 302, memory system 300 reduces data transfer compared to conventional memory system 200 (FIG. 2), where all embedding vectors are transferred to an external processor.

In some implementations, memory system 300 includes aggregation circuitry configured to collect and combine results from multiple similarity circuits 306. As each similarity circuit 306 identifies matched embedding vectors from its corresponding DRAM bank 304, the aggregation circuitry receives the matched embedding vectors or their identifiers from each similarity circuit 306. The aggregation circuitry may rank or merge the results from the multiple similarity circuits 306 to produce a final set of top-K matched embedding vectors across all DRAM banks 304.

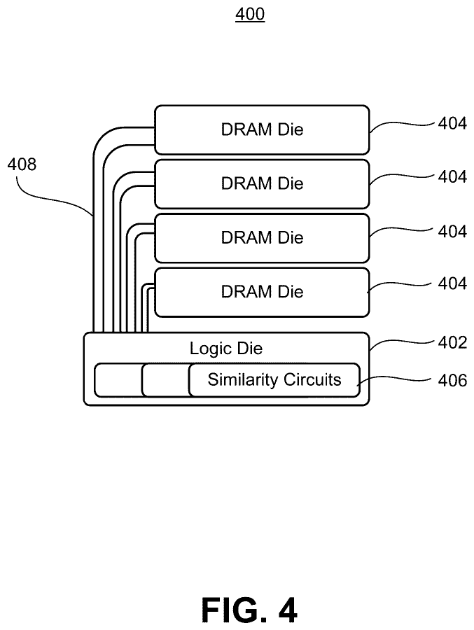

FIG. 4 illustrates a diagram of an example of a memory system 400 with similarity circuitry disposed within a logic die of a high bandwidth memory, in accordance with some aspects of the present technology. Memory system 400 may be referred to as a similarity-near-DRAM (SND) configuration. As shown in FIG. 4, memory system 400 may include a logic die 402, multiple DRAM dies 404, and similarity circuits 406.

DRAM dies 404 and logic die 402 may be arranged in a stacked configuration. In some implementations, DRAM dies 404 and logic die 402 may comprise an HBM. DRAM dies 404 may be configured to store embedding vectors, with the embedding vectors distributed across the multiple DRAM dies 404.

Similarity circuits 406 may be disposed within logic die 402. Embedding vectors stored in DRAM dies 404 may be transferred to logic die 402 via connections 408 for similarity matching. Similarity circuits 406 may receive a search vector and compare the search vector against the embedding vectors to determine similarities and identify matched embedding vectors.

In addition to the similarity circuits 406, logic die 402 may include a memory controller configured to manage read and write operations to the DRAM dies 404. The memory controller may coordinate the transfer of embedding vectors from the DRAM dies 404 to the similarity circuits 406 and manage the storage of new embedding vectors in the DRAM dies 404. The logic die 402 may also include input/output (I/O) circuitry configured to communicate with an external processor, enabling the matched embedding vectors or their identifiers to be transferred out of the memory system 400.

The parallel processing of embedding vectors from multiple DRAM dies 404 may be coordinated by control logic in the logic die 402. The control logic may schedule the transfer of embedding vectors from each DRAM die 404, distribute the embedding vectors to available similarity circuits 406, and collect the results from the similarity circuits 406. In some implementations, each DRAM die 404 is associated with a dedicated similarity circuit 406 or a dedicated set of similarity circuits 406, enabling simultaneous similarity computations for embedding vectors from different DRAM dies 404.

In some implementations, similarity circuits 406 may determine similarities in parallel for embedding vectors stored across multiple DRAM dies 404. By performing similarity matching within logic die 402, memory system 400 reduces data transfer compared to conventional memory system 200 (FIG. 2), where embedding vectors are transferred to an external processor. In memory system 400, only information corresponding to the matched embedding vectors is transferred out of the memory system to a processor, rather than transferring all stored embedding vectors.

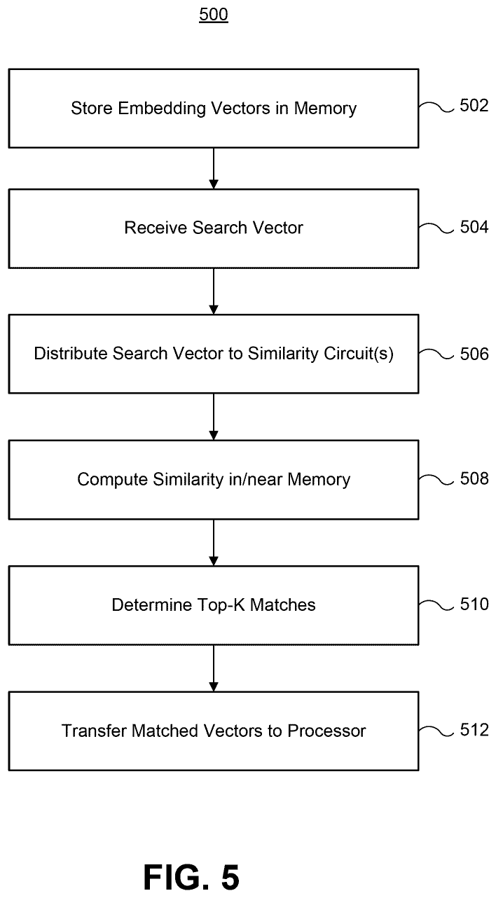

FIG. 5 illustrates a flow chart of an example of a method 500 for similarity matching using a memory system, in accordance with some aspects of the present technology. Method 500 may be performed using memory system 300 (FIG. 3) or memory system 400 (FIG. 4).

At step 502, embedding vectors may be stored in memory circuitry. The embedding vectors may comprise embedded representations of document chunks or other reference materials. The embedding vectors may be stored in memory banks within a memory unit, or across multiple memory units in a stacked configuration.

At step 504, a search vector may be received at similarity circuitry. The search vector may comprise an embedded representation of a query. In some implementations, the similarity circuitry may receive multiple search vectors to enable batch processing of queries.

At step 506, the search vector may be distributed to one or more similarity circuits. In some implementations, the search vector may be distributed to multiple similarity circuits disposed at read ports of memory banks or within a logic die, enabling parallel similarity computations across different portions of the stored embedding vectors.

At step 508, similarity may be computed in or near the memory circuitry. The similarity circuitry may determine similarities between the search vector and the stored embedding vectors using a similarity metric such as cosine similarity, dot product, or Euclidean distance. In some implementations, the similarity circuitry may search multiple memory banks in parallel. Within each memory bank, the similarity circuitry may search row by row, sequentially comparing embedding vectors as they are read from each row.

At step 510, top-K matches may be determined. The similarity circuitry may identify a predetermined number of matched embedding vectors with highest similarities to the search vector. The matched embedding vectors may be ranked based on their similarity scores.

At step 512, information corresponding to the matched embedding vectors may be transferred to a processor. In some implementations, only information corresponding to the matched embedding vectors is transferred out of the memory system, rather than transferring all stored embedding vectors. This approach reduces data movement between the memory and processor, improving energy efficiency and reducing latency.

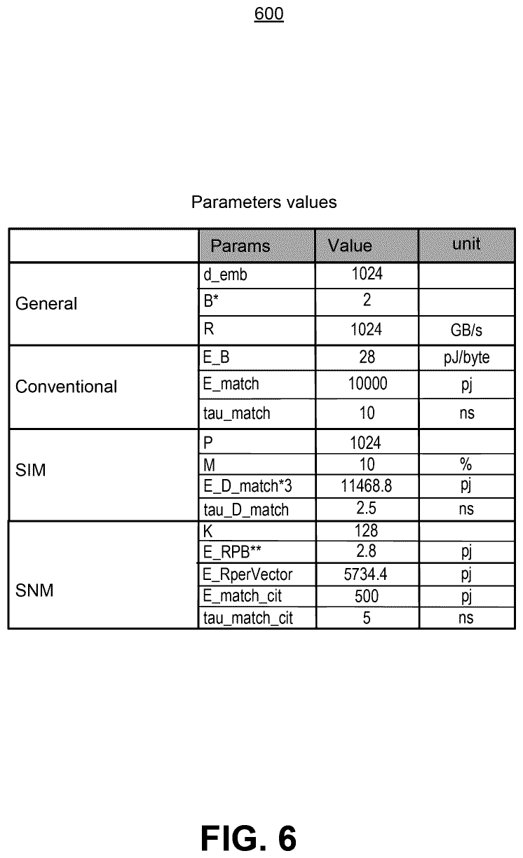

FIG. 6 illustrates a table 600 of example parameters for performance analysis of memory systems for similarity matching, in accordance with some aspects of the present technology. Table 600 includes parameters for general system configuration, conventional architecture, similarity-in-DRAM (SID) configuration, and similarity-near-DRAM (SND) configuration.

General parameters may include an embedding dimension (d_emb), a precision in bytes (B), and a memory bandwidth (R). The embedding dimension represents the number of elements in each embedding vector. The precision represents the number of bytes used to store each element of the embedding vector. The memory bandwidth represents the data transfer rate between the memory and a processor. In the example shown in FIG. 6, the embedding dimension may be 1024, the precision may be 2 bytes, and the memory bandwidth may be 1024 GB/s.

Conventional architecture parameters may include a DRAM energy per byte (E_B), a similarity matching energy per vector (E_match), and a similarity matching latency per vector (tau_match). The DRAM energy per byte represents the energy consumed to transfer one byte of data from memory. The similarity matching energy represents the energy consumed to perform similarity matching for one embedding vector. The similarity matching latency represents the time required to perform similarity matching for one embedding vector. In the example shown in FIG. 6, the DRAM energy per byte may be 28 pJ/byte, the similarity matching energy may be 10000 pJ, and the similarity matching latency may be 10 ns.

SID configuration parameters may include a number of parallel memory banks (P), a number of top matched vectors (M), a DRAM similarity matching energy per vector (E_D_match), and a DRAM similarity matching latency per vector (tau_D_match). The number of parallel memory banks represents the number of memory banks that may be searched simultaneously. The number of top matched vectors represents the number of matched embedding vectors to be returned from the similarity matching operation. In the example shown in FIG. 6, the number of parallel memory banks may be 1024, the number of top matched vectors may be 10% of the total embedding vectors, the DRAM similarity matching energy may be 11468.8 pJ, and the DRAM similarity matching latency may be 2.5 ns.

SND configuration parameters may include a number of similarity matching circuits (K), a DRAM read energy per byte (E_RPB), an energy per vector for similarity matching (E_RperVector), a similarity circuit matching energy (E_match_cit), and a similarity circuit matching latency (tau_match_cit). The number of similarity matching circuits represents the number of similarity circuits disposed within a logic die for parallel similarity computations. In the example shown in FIG. 6, the number of similarity matching circuits may be 128, the DRAM read energy per byte may be 2.8 pJ, the energy per vector may be 5734.4 pJ, the similarity circuit matching energy may be 500 pJ, and the similarity circuit matching latency may be 5 ns.

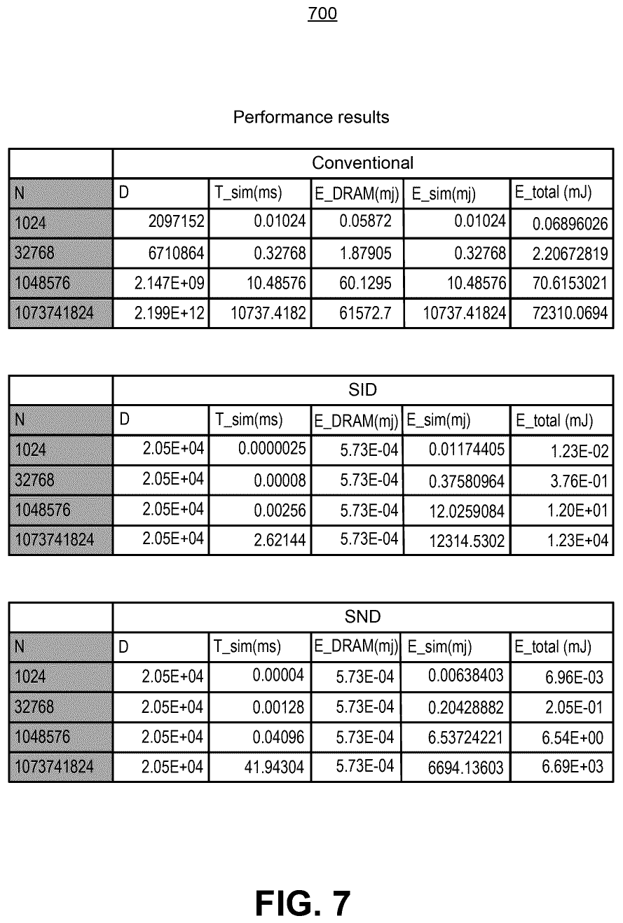

FIG. 7 illustrates a table 700 of example performance results for conventional, SID, and SND memory system configurations, in accordance with some aspects of the present technology. Table 700 shows performance metrics including total data transferred (D), similarity matching latency (T_sim), DRAM energy (E_DRAM), similarity matching energy (E_sim), and total energy (E_total) for varying numbers of embedding vectors (N).

For the conventional architecture, the total amount of data transferred from memory may be calculated as D=N×d_{emb}×B, where N is the number of embedding vectors, d_{emb} is the embedding dimension, and B is the precision in bytes. The total similarity matching latency may be calculated as Tₛᵢₘ=N×τ_{match}, where τ_match is the matching latency per vector. The total DRAM energy may be calculated as E_{DRAM}_{ₜₒₜₐₗ}=D×E_{B}, where E_{B} is the DRAM energy per byte. The total similarity matching energy may be calculated as Eₛᵢₘ=N×E_{match}, where E_{match} is the matching energy per vector. The total energy may be calculated as Eₜₒₜₐₗ=E_{DRAM}_{ₜₒₜₐₗ}+Eₛᵢₘ.

For the SID configuration, the total amount of data transferred from memory may be calculated as D=M×d_{emb}×B, where Mis the number of top matched vectors. Because similarity matching is performed within the memory, only the matched embedding vectors are transferred out of the memory, substantially reducing data movement. The total similarity matching latency may be calculated as

$${T}_{sim} = \frac{N}{P} \times {τ}_{D \_ match} ,$$

where P is the number of parallel memory banks and τ_{D_match} is the DRAM matching latency per vector. By searching multiple memory banks in parallel, the SID configuration reduces similarity matching latency compared to the conventional architecture. The total similarity matching energy may be calculated as Eₛᵢₘ=N×E_{D_match}, where E_{D_match} is the DRAM matching energy per vector.

For the SND configuration, the total amount of data transferred from memory may be calculated as D=M×d_{emb}×B, where Mis the number of top matched vectors. Similar to the SID configuration, only the matched embedding vectors are transferred out of the memory system. The total similarity matching latency may be calculated as

$${T}_{sim} = \frac{N}{K} \times {τ}_{match \_ cit} ,$$

where K is the number of similarity matching circuits and τ_{match_cit} is the similarity circuit matching latency per vector. The similarity circuits disposed within the logic die enable parallel similarity computations across the embedding vectors. The total similarity matching energy may be calculated as Eₛᵢₘ=N×E_{D_match}, where E_{D_match} is the similarity circuit matching energy per vector.

Table 700 illustrates performance results for different numbers of embedding vectors (N), including N=1024, N=32768, N=1048576, and N=1073741824. As shown in FIG. 7, the conventional architecture exhibits increasing data transfer, latency, and energy consumption as the number of embedding vectors grows. In contrast, the SID and SND configurations demonstrate substantially reduced data transfer by performing similarity matching within or near the memory and transferring only the matched embedding vectors. The SID configuration achieves reduced latency through parallel memory bank searching, while the SND configuration achieves reduced latency through parallel similarity circuits in the logic die.

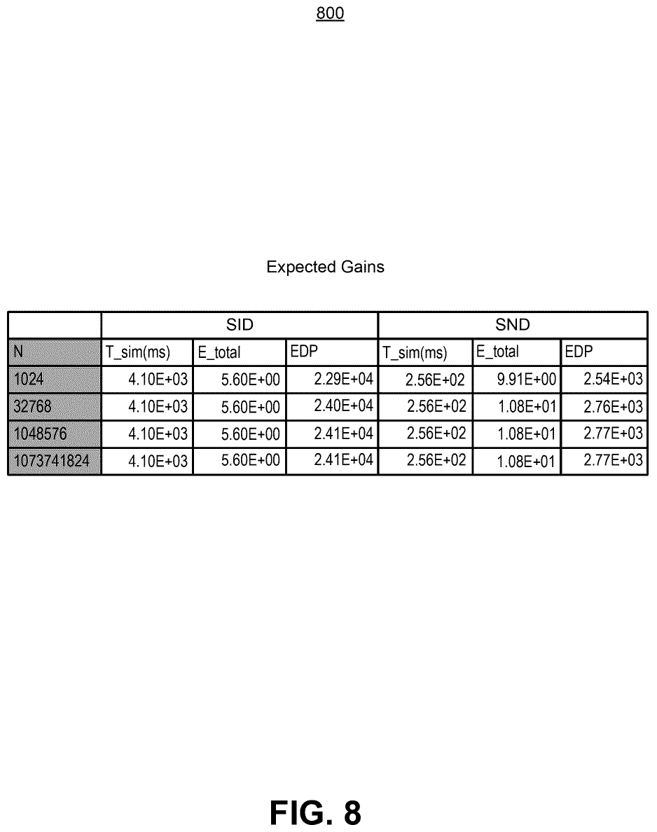

FIG. 8 illustrates a table 800 of example expected gains for SID and SND memory system configurations, in accordance with some aspects of the present technology. Table 800 shows energy-delay product (EDP) gains for the SID and SND configurations compared to the conventional architecture. The energy-delay product is a metric that combines energy consumption and latency, calculated as the product of total energy and similarity matching latency. A higher EDP gain indicates improved efficiency in both energy and performance.

As shown in FIG. 8, the SID and SND configurations achieve substantial EDP gains compared to the conventional architecture. In the example shown in FIG. 8, the SID configuration achieves EDP gains of more than 22,000 times compared to the conventional architecture, while the SND configuration achieves EDP gains of more than 2,500 times compared to the conventional architecture. The SID configuration achieves higher EDP gains than the SND configuration because the similarity circuitry is disposed within the memory die at read ports of the memory banks, further reducing data movement and energy consumption. The SND configuration, while achieving lower EDP gains than the SID configuration, provides flexibility by disposing the similarity circuitry within the logic die of a high bandwidth memory.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

A number of implementations have been described. Nevertheless, it will be understood that various modifications may be made without departing from the spirit and scope of the disclosure. Accordingly, other implementations are within the scope of the following claims.

It is understood that the described systems or apparatuses are not mutually exclusive, and elements, components, materials, or steps described in connection with one example method, system, or apparatus may be combined with, or eliminated from, other disclosed methods, systems, or apparatuses in suitable ways to accomplish desired design objectives.

In the foregoing specification, the disclosed systems or apparatuses have been described with reference to numerous specific details that can vary from implementation to implementation. Certain adaptations and modifications of the described systems or apparatuses can be made. Various renditions of the disclosed systems or apparatuses can be apparent to those skilled in the art from consideration of the specification and practice of the invention disclosed herein. It is intended that the specification and examples be considered as exemplary only.

It should be understood that the various embodiments described herein are not mutually exclusive and may be combined, modified, or interchanged in whole or in part without departing from the scope of the disclosed technology. Features illustrated or described in connection with one embodiment may be incorporated into other embodiments to form additional implementations. For example, memory system configurations, similarity circuitry arrangements, memory bank organizations, and stacked memory architectures, described with respect to any of FIGS. 1-8 may be selectively integrated to achieve desired similarity matching performance, memory efficiency, or reduced data movement. Accordingly, the disclosed technology encompasses all such combinations and variations that fall within the spirit and scope of the appended claims.

The present technology includes devices, apparatuses, and assemblies addressed in the aspects of the present technology presented below:

Aspect I: A memory system including:
memory circuitry configured to store a plurality of embedding vectors; and
similarity circuitry configured to:
   receive a search vector,
   determine similarities between the search vector and the plurality of embedding vectors,
   identify one or more matched embedding vectors based on the similarities, and
   output information corresponding to the one or more matched embedding vectors.
Aspect II: The memory system of Aspect I, wherein the memory circuitry includes a plurality of memory banks.
Aspect III: The memory system of any of Aspects I-II, wherein the similarity circuitry is further configured to identify a predetermined number of matched embedding vectors with highest similarities to the search vector.
Aspect IV: The memory system of any of Aspects I-III, wherein the similarity circuitry includes a plurality of similarity circuits configured to receive the search vector.

Aspect V: The memory system of Aspect II, wherein the memory circuitry comprises at least one memory unit, and wherein the similarity circuitry is disposed within the at least one memory unit.

Aspect VI: The memory system of Aspect V, wherein the similarity circuitry is disposed at read ports of the plurality of memory banks.

Aspect VII: The memory system of Aspect VI, wherein the plurality of memory banks is configured to be searched in parallel, wherein at least a subset of the plurality of memory banks are associated with respective similarity circuits.

Aspect VIII: The memory system of Aspect II, further including a logic die, wherein the memory circuitry comprises a plurality of memory units, and wherein the logic die is configured to receive the plurality of embedding vectors from the plurality of memory units.

Aspect IX: The memory system of Aspect VIII, wherein the plurality of memory units and the logic die are arranged in a stacked configuration.

Aspect X: The memory system of Aspect IX, wherein the similarity circuitry is disposed within the logic die.

Aspect XI: The memory system of Aspect IX, wherein the plurality of memory units and the logic die include a high bandwidth memory.

Aspect XII: The memory system of Aspect X, wherein the similarity circuitry is configured to determine the similarities in parallel for the plurality of embedding vectors stored across the plurality of memory units.

Aspect XIII: The memory system of any of Aspects I-XII, further including a processor coupled to the similarity circuitry and configured to receive the one or more matched embedding vectors and perform inference using the one or more matched embedding vectors.

Aspect XIV: The memory system of any of Aspects I-XIII, wherein the memory system is configured to perform retrieval in a retrieval-augmented generation system.

Aspect XV: The memory system of any of Aspects I-XIV, wherein the search vector includes an embedded representation of a query.

Aspect XVI: The memory system of any of Aspects I-XV, wherein the plurality of embedding vectors includes embedded representations of document chunks.

Aspect XVII: A method including:
storing a plurality of embedding vectors in memory circuitry;
receiving, by similarity circuitry, a search vector;
determining, by the similarity circuitry, similarities between the search vector and the plurality of embedding vectors;
identifying one or more matched embedding vectors based on the similarities; and
outputting information corresponding to the one or more matched embedding vectors.

Aspect XVIII: The method of Aspect XVII, wherein identifying the one or more matched embedding vectors includes identifying a predetermined number of embedding vectors with highest similarities to the search vector.

Aspect XIX: The method of any of Aspects XVII-XVIII, further including:
distributing the search vector to a plurality of similarity circuits; and
transferring the one or more matched embedding vectors to a processor.

Aspect XX: A memory system, including:
a plurality of memory banks comprising read ports and configured to store a plurality of embedding vectors; and
similarity circuitry disposed at the read ports of the plurality of memory banks, the similarity circuitry configured to:
   receive a search vector;
   for at least a subset of the plurality of memory banks, determine one or more similarities between the search vector and one or more embedding vectors read from a read port of that memory bank;
   based on the one or more determined similarities, identify one or more matched embedding vectors; and
   output, from the memory system, information corresponding to the one or more matched embedding vectors.

Aspect XXI: The memory system of any of Aspects I-XVI, wherein only the one or more matched embedding vectors are transferred out of the memory system.

Aspect XXII: The memory system of Aspect V, wherein the similarity circuitry is configured to search the plurality of memory banks row by row.

Aspect XXIII: The memory system of any of Aspects I-XVI and XXI-XXII, wherein the similarity circuitry is configured to receive a plurality of search vectors and determine similarities for the plurality of search vectors.

What is claimed is:

1. A memory system comprising:
memory circuitry configured to store a plurality of embedding vectors; and
similarity circuitry configured to:
receive a search vector,
determine similarities between the search vector and the plurality of embedding vectors,
identify one or more matched embedding vectors based on the similarities, and
output information corresponding to the one or more matched embedding vectors.

2. The memory system of claim 1, wherein the memory circuitry comprises a plurality of memory banks.

3. The memory system of claim 1, wherein the similarity circuitry is further configured to identify a predetermined number of matched embedding vectors with highest similarities to the search vector.

4. The memory system of claim 1, wherein the similarity circuitry comprises a plurality of similarity circuits configured to receive the search vector.

5. The memory system of claim 2, wherein the memory circuitry comprises at least one memory unit, and wherein the similarity circuitry is disposed within the at least one memory unit.

6. The memory system of claim 5, wherein the similarity circuitry is disposed at read ports of the plurality of memory banks.

7. The memory system of claim 6, wherein the plurality of memory banks is configured to be searched in parallel, wherein at least a subset of the plurality of memory banks are associated with respective similarity circuits.

8. The memory system of claim 2, further comprising a logic die, wherein the memory circuitry comprises a plurality of memory units, and wherein the logic die is configured to receive the plurality of embedding vectors from the plurality of memory units.

9. The memory system of claim 8, wherein the plurality of memory units and the logic die are arranged in a stacked configuration.

10. The memory system of claim 9, wherein the similarity circuitry is disposed within the logic die.

11. The memory system of claim 9, wherein the plurality of memory units and the logic die comprise a high bandwidth memory.

12. The memory system of claim 10, wherein the similarity circuitry is configured to determine the similarities in parallel for the plurality of embedding vectors stored across the plurality of memory units.

13. The memory system of claim 1, further comprising a processor coupled to the similarity circuitry and configured to receive the one or more matched embedding vectors and perform inference using the one or more matched embedding vectors.

14. The memory system of claim 1, wherein the memory system is configured to perform retrieval in a retrieval-augmented generation system.

15. The memory system of claim 1, wherein the search vector comprises an embedded representation of a query.

16. The memory system of claim 1, wherein the plurality of embedding vectors comprises embedded representations of document chunks.

17. A method comprising:
storing a plurality of embedding vectors in memory circuitry;
receiving, by similarity circuitry, a search vector;
determining, by the similarity circuitry, similarities between the search vector and the plurality of embedding vectors;
identifying one or more matched embedding vectors based on the similarities; and
outputting information corresponding to the one or more matched embedding vectors.

18. The method of claim 17, wherein identifying the one or more matched embedding vectors comprises identifying a predetermined number of embedding vectors with highest similarities to the search vector.

19. The method of claim 17, further comprising:
distributing the search vector to a plurality of similarity circuits; and
transferring the one or more matched embedding vectors to a processor.

20. A memory system, comprising:
a plurality of memory banks comprising read ports and configured to store a plurality of embedding vectors; and
similarity circuitry disposed at the read ports of the plurality of memory banks, the similarity circuitry configured to:
receive a search vector;
for at least a subset of the plurality of memory banks, determine one or more similarities between the search vector and one or more embedding vectors read from a read port of that memory bank;
based on the one or more determined similarities, identify one or more matched embedding vectors; and
output, from the memory system, information corresponding to the one or more matched embedding vectors.
